(19) United States
(12) Patent Application Publication
(10) Pub. No.: US 2026/0099495 A1
(43) Pub. Date: Apr. 9, 2026

(54) HOST DEVICE, STORAGE DEVICE AND SYSTEM AND METHOD THEREOF

(71) Applicant: Samsung Electronics Co., Ltd., Suwon-si (KR)

(72) Inventors: Zhonggang CHEN, Xi'an (CN); Jongtae PARK, Xi'an (CN); Fei DONG, Xi'an (CN)

(73) Assignee: Samsung Electronics Co., Ltd., Suwon-si (KR)

(21) Appl. No.: 18/943,160

(22) Filed: Nov. 11, 2024

(30) Foreign Application Priority Data
Oct. 9, 2024 (CN) 202411411753.1

(51) Int. Cl. G06F 16/2455; G06F 16/22

(52) U.S. Cl. CPC G06F 16/2455; G06F 16/2246

(57) ABSTRACT

There is provided a host device, a storage device and a system and a method thereof. A B-tree based retrieval method performed by the host device includes acquiring query information from a storage of a storage device based on a B-tree query request for a table; sending the query information to the storage device for storing into a memory of the storage device; sending the B-tree query request to the storage device to initiate a query for the table at the storage device; and receiving a result of the B-tree query request from the storage device.

This U.S. non-provisional application claims the benefit of priority under 35 U.S.C. 119 from Chinese Patent Application No. 202411411753.1, filed on Oct. 9, 2024 in the Chinese Intellectual Property Office, the entire contents of which are herein incorporated by reference.

### TECHNICAL FIELD

The present inventive concepts relate to the fields of B-tree based retrieval, and more particularly, relate to host devices, storage devices and systems and methods thereof.

### BACKGROUND

Recently, when a B-tree based retrieval is performed using, for example, My Structured Query Language (MySQL), if a key is retrieved in a primary index, a page where the key is located and its primary key value may be retrieved by performing an input/output (I/O) operation between a host device and a storage device, and then a complete row of the key may be retrieved, at which time there is no need to perform the I/O operation to obtain an additional column. Here, the B-tree may refer to a self-balancing data structure that stores/retrieves data and is used for searching, insertion, and/or deletion operation. On the other hand, if a key is retrieved in a secondary index, a page where the key is located and its key value may be retrieved. The key value is a pointer pointing to a complete row that actually exists and the key value is usually a primary key value. In this case, any retrieval involving the secondary index must be operated by performing the I/O operation, starting at a root node and navigating through a branch node to the correct leaf node in the secondary index to acquire the primary key value, and then again by performing the I/O operation, navigating from the root node through the branch node in the primary index to the correct leaf node to acquire data.

### SUMMARY

According to some example embodiments of the present inventive concepts, there is provided a B-tree based retrieval method performed by a host device, including acquiring query information from a storage of a storage device based on a B-tree query request for a table; sending the query information to the storage device for storing into a memory of the storage device; sending the B-tree query request to the storage device to initiate a query for the table at the storage device; and receiving a result of the B-tree query request from the storage device.

A target field of the B-tree query request may be a field that is not contained in leaf nodes of a secondary index of the table.

The query information may include at least one of all fields of the table and length information thereof, at least one field of the table requested to be queried by the B-tree query request, page number information of root nodes of a primary index and the secondary index of the table, and a size of a B-tree page.

The sending the B-tree query request and the query information to the storage device may include packaging the B-tree query request and the query information through a predetermined (or, alternatively, desired or selected) protocol to send to the storage device.

According to some example embodiments of the present inventive concepts, there is provided a host device, including a storage; and a processor configured to acquire query information from the storage of a storage device based on a B-tree query request for a table; send the query information to the storage device for storing into a memory of the storage device; send the B-tree query request to the storage device to initiate a query for the table at the storage device; and receive a result of the B-tree query request from the storage device.

A target field of the B-tree query request may be a field that is not contained in leaf nodes of a secondary index of the table.

The query information may include at least one of all fields of the table and length information thereof, at least one field of the table requested to be queried by the B-tree query request, page number information of root nodes of a primary index and the secondary index of the table, and a size of a B-tree page.

The at least one processor may further be configured to package the B-tree query request and the query information through a predetermined (or, alternatively, desired or selected) protocol to send to the storage device.

According to some example embodiments of the present inventive concepts, there is provided a B-tree based retrieval method performed by a storage device, including receiving, from a host device, and storing query information into a memory; receiving a B-tree query request from the host device to initiate a query for a table; acquiring a result of the B-tree query request by using the query information; and sending the result of the B-tree query request to the host device.

A target field of the B-tree query request may be a field that is not contained in leaf nodes of a secondary index of the table.

The query information may include at least one of all fields of the table and length information thereof, at least one field of the table requested to be queried by the B-tree query request, page number information of root nodes of a primary index and the secondary index of the table, and a size of a B-tree page.

The acquiring the result of the B-tree query request may include acquiring a primary key value of a root page of at least one target root node of the table corresponding to the B-tree query request by traversing and retrieving a root page of each root node of the secondary index of the table using the query information; and acquiring a key value of the target field corresponding to the B-tree query request as the result of the B-tree query request by traversing and retrieving a root page of a root node, corresponding to the primary key value, of the primary index of the table using the query information.

The acquiring the primary key value of the root page of at least one target root node of the table corresponding to the B-tree query request may include based on all fields of the table and length information thereof and the page number information of root nodes of the secondary index of the table, loading the root page of each root node of the secondary index of the table stored in a storage of the storage device into the memory of the storage device with the size of the B-tree page respectively for retrieval, so as to acquire the primary key value of the root page of the at least one target root node.

The acquiring the key value of the target field corresponding to the B-tree query request as the result of the B-tree query request may include based on all fields of the table and length information thereof and the page number information of root nodes of the primary index of the table, loading the root page of the root node corresponding to the primary key value of the primary index of the table stored in the storage of the storage device into the memory of the storage device with the size of the B-tree page respectively for retrieval, so as to acquire the key value of the target field.

The B-tree based retrieval method may further include sorting the primary key value, and sequentially loading root pages of root nodes corresponding to the sorted primary key value into the memory of the storage device for retrieval.

According to some example embodiments of the present inventive concepts, there is provided a storage device, including a storage; a memory; and a processor configured to receive, from a host device, and store query information into the memory; receive a B-tree query request from the host device to initiate a query for a table; acquire a result of the B-tree query request by using the query information; and send the result of the B-tree query request to the host device.

A target field of the B-tree query request may be a field that is not contained in leaf nodes of a secondary index of the table.

The query information may include at least one of all fields of the table and length information thereof, at least one field of the table requested to be queried by the B-tree query request, page number information of root nodes of a primary index and the secondary index of the table, and a size of a B-tree page.

The processor may further be configured to acquire a primary key value of a root page of at least one target root node of the table corresponding to the B-tree query request by traversing and retrieving a root page of each root node of the secondary index of the table using the query information; and acquire a key value of the target field corresponding to the B-tree query request as the result of the B-tree query request by traversing and retrieving a root page of a root node, corresponding to the primary key value, of the primary index of the table using the query information.

The processor may further be configured to, based on all fields of the table and length information thereof and the page number information of root nodes of the secondary index of the table, load the root page of each root node of the secondary index of the table stored in a storage of the storage device into the memory of the storage device with the size of the B-tree page respectively for retrieval, so as to acquire the primary key value of the root page of the at least one target root node.

The processor may further be configured to, based on all fields of the table and length information thereof and the page number information of root nodes of the primary index of the table, load the root page of the root node corresponding to the primary key value of the primary index of the table stored in the storage of the storage device into the memory of the storage device with the size of the B-tree page respectively for retrieval, so as to acquire the key value of the target field.

The processor may further be configured to sort the primary key value, and sequentially load root pages of root nodes corresponding to the sorted primary key value into the memory of the storage device for retrieval.

According to some example embodiments of the present inventive concepts, there is provided a system for performing a B-tree storage application retrieval including the previously mentioned host device and the previously mentioned storage device.

According to some example embodiments of the present inventive concepts, there is provided a computer-readable medium having stored thereon computer executable instructions that, in response to being executed, executes the previously mentioned method.

According to some example embodiments of the present inventive concepts, by retrieving target data inside a storage device, a large amount of data migration between a host device and the storage device may be avoided, so that an amount of data movement between the host device and the storage device may be reduced, a resource utilization rate and a bandwidth consumption of the host device may be reduced and a bandwidth utilization rate may be improved, an I/O bandwidth in the storage device may be improved, a delay of retrieving the target data may be reduced, and retrieval performance may be improved.

### BRIEF DESCRIPTION OF THE DRAWINGS

The above and other purposes and features will become more apparent from the following detailed descriptions, taken in conjunction with the accompanying drawings in which:

FIG. 1 is a schematic diagram illustrating a B-tree retrieval;

FIG. 2 is a flowchart illustrating a B-tree based retrieval method performed by a host device according to some example embodiments of the present inventive concepts;

FIG. 3 is a flowchart illustrating a B-tree based retrieval method performed by a storage device according to some example embodiments of the present inventive concepts;

FIG. 4 is a block diagram illustrating a host device according to some example embodiments of the present inventive concepts;

FIG. 5 is a block diagram illustrating a storage device according to some example embodiments of the present inventive concepts;

FIG. 6 is a block diagram illustrating a system according to some example embodiments of the present inventive concepts;

FIG. 7 is a schematic diagram illustrating a system to which a storage device is applied according to some example embodiments of the present inventive concepts;

FIG. 8 is a block diagram illustrating a host storage system according to some example embodiments of the present inventive concepts; and

FIG. 9 is a diagram illustrating a data center to which a storage device is applied according to some example embodiments of the present inventive concepts.

### DETAILED DESCRIPTION OF EXEMPLARY EMBODIMENTS

Hereinafter, various example embodiments of the present inventive concepts are described with reference to the accompanying drawings, in which the same reference numerals are used to depict the same or similar elements, features, and structures. However, the present inventive concepts are not intended to be limited by the various example embodiments described herein to a specific embodiment and it is intended that the present inventive concepts cover all modifications, equivalents, and/or alternatives of the present inventive concepts, provided they come within the scope of the appended claims and their equivalents. The terms and words used in the following description and claims are not limited to their dictionary meanings, but, are merely used to enable a clear and consistent understanding of the present inventive concepts. Accordingly, it should be apparent to those skilled in the art that the following descriptions of various example embodiments of the present inventive concepts are provided for illustration purpose only and not for the purpose of limiting the present inventive concepts as defined by the appended claims and their equivalents.

It is to be understood that the singular forms include plural forms, unless the context clearly indicates otherwise. The terms “include”, “contain”, and “have”, used herein, indicate functions, operations, or the existence of elements of the inventive concepts, but do not exclude other functions, operations, or elements.

For example, the expressions “A or B”, or “at least one of A and/or B” may indicate A and B, and A or B. For example, the expression “A or B” or “at least one of A and/or B” may indicate (1) A, (2) B, or (3) both A and B.

In various example embodiments of the present inventive concepts, it is intended that when a component (for example, a first component) is referred to as being “coupled” or “connected” with/to another component (for example, a second component), the component may be directly connected to the another component or may be connected through another component (for example, a third component). In contrast, when a component (for example, a first component) is referred to as being “directly coupled” or “directly connected” with/to another component (for example, a second component), another component (for example, a third component) does not exist between the component and the another component.

The expression “configured to”, used in describing various example embodiments of the present inventive concepts, may be used interchangeably with expressions such as “suitable for”, “having the capacity to . . . ”, “designed to”, “adapted to”, “made to”, and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain example embodiments of the present inventive concepts, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present inventive concepts are not intended to be interpreted as excluding the example embodiments of the present inventive concepts.

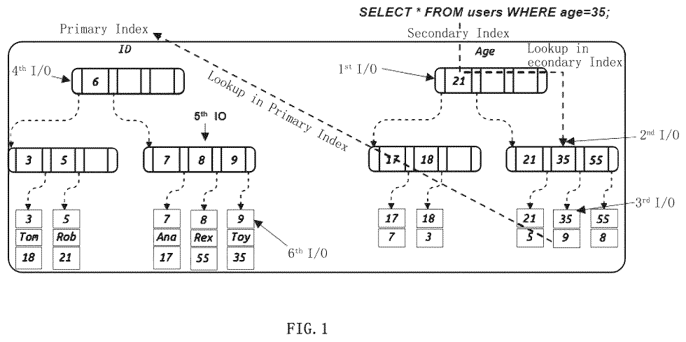

FIG. 1 is a schematic diagram illustrating a B-tree retrieval. As illustrated in FIG. 1, in the case where a height of a B-tree is three layers, if an advance cache is not considered, a host device interacts with a storage device 6 times. In addition, most of the I/O operations between the host device and the storage device are random IOs, resulting in high read overhead. The above phenomenon will cause a large amount of invalid data to move between the host device and the storage device, consume bandwidth resources, and affect performance at the same time.

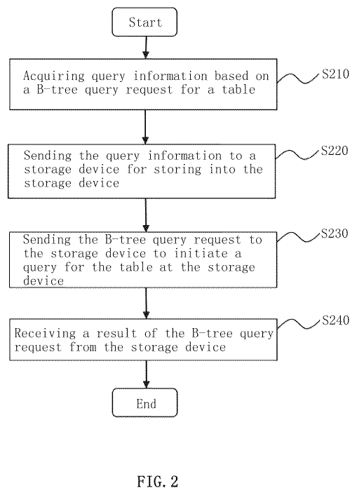

FIG. 2 is a flowchart illustrating a B-tree based retrieval method performed by a host device according to some example embodiments of the present inventive concepts.

Referring to FIG. 2, in operation S210, query information may be acquired from a storage of a storage device based on a B-tree query request for a table. Only as an example rather than a limitation, a target field of the B-tree query request may be a field that is not contained in leaf nodes of a secondary index of the table. In addition, the query information may include at least one of all fields of the table and length information thereof, at least one field of the table requested to be queried by the B-tree query request, page number information of root nodes of a primary index and the secondary index of the table, and a size of a B-tree page. According to some example embodiments of the present inventive concepts, the B-tree query request for the table may be acquired by a database application (e.g., a B-tree storage application) of the host device.

According to some example embodiments of the present inventive concepts, in operation S210, the B-tree query request for the table may be an SQL statement, but is not limited thereto, and the query information may be acquired based on “Select” and “Where” in the SQL statement. Here, the page number information of the root nodes of the primary index and the secondary index of the table may be acquired by querying database dictionary information (e.g., Logical Block Address (LBA) information) from the storage of the storage device based on the SQL statement. In addition, the size of the B-tree page may be acquired from an InnoDB module in the database application of the host device, and the size of the B-tree page may be a default value (e.g., 16K, etc.) in the InnoDB module.

In operation S220, the query information may be sent to the storage device for storing into a memory of the storage device. According to some example embodiments of the present inventive concepts, the storage device may firstly be discovered, the memory is requested to the storage device, the memory of the storage device is mapped to the host device, and the query information is then sent to the storage device to store the query information into the memory of the storage device.

In operation S230, the B-tree query request may be sent to the storage device to initiate a query for the table at the storage device.

According to some example embodiments of the present inventive concepts, the sending operations in operation S220 and operation S230 may package the B-tree query request and the query information through a predetermined (or, alternatively, desired or selected) protocol to send to the storage device. Only as an example rather than a limitation, the predetermined (or, alternatively, desired or selected) protocol may be the Storage Networking Industry Association (SNIA) Computing Storage (CS) Application Programming Interface (API) or Open Computing Language (OpenCL). In addition, when the storage device is a Non-Volatile Memory express (NVMe) device, packaged information may further be sent to the storage device through an NVMe interface protocol by an NVMe device driver (e.g., an NVMe TP4091 device driver, etc.). When the storage device is an NVMe device, before packaging the B-tree query request in operation S230, the B-tree query request may firstly be transformed into an NVMe computing command (e.g., a storage device configuration command, a B-tree traversal command, etc.), and then be packaged and sent.

In operation S240, a result of the B-tree query request may be received from the storage device.

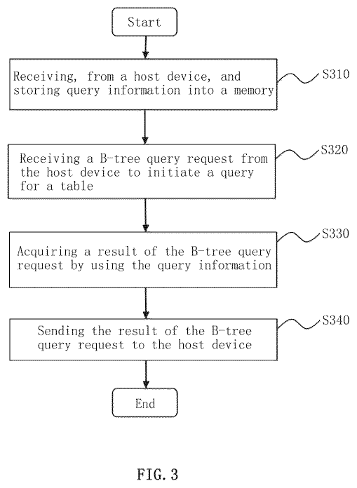

FIG. 3 is a flowchart illustrating a B-tree based retrieval method performed by a storage device according to some example embodiments of the present inventive concepts.

Referring to FIG. 3, in operation S310, the query information may be received from the host device and be stored into the memory. Here, only as an example rather than a limitation, a target field of the B-tree query request may be a field that is not contained in leaf nodes of a secondary index of the table. In addition, the query information may include all fields of the table and length information thereof, at least one field of the table requested to be queried by the B-tree query request, page number information of root nodes of the primary index and the secondary index of the table, and a size of a B-tree page. According to some example embodiments of the present inventive concepts, the query information may be stored in a database configuration module in the memory.

In operation S320, a B-tree query request may be received from the host device to initiate a query for a table. According to some example embodiments of the present inventive concepts, the processor included in the storage device may be a Computational Storage Engine (CSE), the CSE may include a Computational Storage Engine Entity (CSEE), and the CSEE may select a Computational Storage Function (CSF) for performing the following operations from at least one CSF included therein.

In operation S330, a result of the B-tree query request may be acquired by using the query information. According to some example embodiments of the present inventive concepts, the acquiring the result of the B-tree query request in operation S330 may further include acquiring a primary key value of a root page of at least one target root node of the table corresponding to the B-tree query request by traversing and retrieving a root page of each root node of the secondary index of the table using the query information; and acquiring a key value of the target field corresponding to the B-tree query request as the result of the B-tree query request by traversing and retrieving a root page of a root node, corresponding to the primary key value, of the primary index of the table using the query information. That is to say, the above operations traverse the secondary index and the primary index to acquire the key value of the target field, and may repeatedly load the root pages of the root nodes into the memory of the storage device for retrieval.

According to some example embodiments of the present inventive concepts, more specifically, the acquiring the primary key value of the root page of at least one target root node of the table corresponding to the B-tree query request may include based on all fields of the table and length information thereof and the page number information of root nodes of the secondary index of the table, loading the root page of each root node of the secondary index of the table stored in a storage of the storage device into the memory of the storage device with the size of the B-tree page respectively for retrieval, so as to acquire the primary key value of the root page of the at least one target root node.

According to some example embodiments of the present inventive concepts, more specifically, the acquiring the key value of the target field corresponding to the B-tree query request as the result of the B-tree query request may include based on all fields of the table and length information thereof and the page number information of root nodes of the primary index of the table, loading the root page of the root node, corresponding to the primary key value, of the primary index of the table stored in the storage of the storage device into the memory of the storage device with the size of the B-tree page respectively for retrieval, so as to acquire the key value of the target field.

According to some example embodiments of the present inventive concepts, the next root node to be loaded may be determined based on the key value, and the page number information of the next root node may be acquired. In addition, according to some example embodiments of the present inventive concepts, the key value of the target field as the result of the B-tree query request may be stored in the memory of the storage device.

According to some example embodiments of the present inventive concepts, in the above specific operations of operation S330, based on the page number information of root nodes of the secondary index of the table and/or the page number information of root nodes of the primary index of the table, a destination address and a source address thereof in the storage of the storage device may be acquired, a Direct Memory Access (DMA) negotiation with a storage controller included in the storage device may be initiated and a DMA data transmission channel between the storage and the memory of the storage device may be established to load the corresponding root pages into the memory of the storage device. In addition, in the above retrieval process, comparison and retrieval of key values may be implemented through a comparator of the CSF. For example, an input of the comparator may be a key value A and a key value B for comparison, and an output may be A_greater_B, i.e. if A>B, it is a high level, and otherwise, it is a low level; A_equal_B, i.e. if A=B, it is a high level, and otherwise, it is a low level; A_less_B, i.e. if A<B, it is a high level, and otherwise, it is a low level.

Alternatively, according to some example embodiments of the present inventive concepts, after acquiring the primary key value of the root page of the at least one target root node, the primary key value may be sorted, and root pages of root nodes corresponding to the sorted primary key value may be sequentially loaded into the memory of the storage device for retrieval. Only as an example rather than a limitation, the primary key value may be sorted according to a key value size. Sorting the primary key value may optimize retrieval performance and reduce retrieval time.

In operation S340, the result of the B-tree query request may be sent to the host device. According to some example embodiments of the present inventive concepts, similar to sending the query information and the B-tree query request to the storage device, the result of the B-tree query request may be packaged through a predetermined (or, alternatively, desired or selected) protocol to be sent to the host device, which will not be described here.

In addition, according to some example embodiments of the present invention concepts, before sending the result of the B-tree query request to the host device, interrupt information may be sent to the host device to indicate that the result of the B-tree query request has been retrieved, the result of the B-tree query request may then be acquired from the memory by a query server module in the host device, and the result may be returned to the database application of the host device.

In addition, according to some example embodiments of the present inventive concepts, the storage device may further send the query information to the host device.

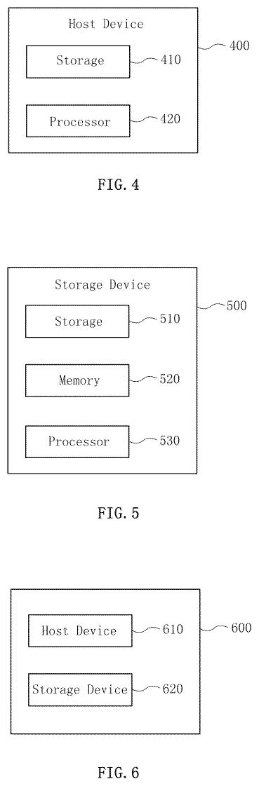

FIG. 4 is a block diagram illustrating a host device 400 according to some example embodiments of the present inventive concepts.

Referring to FIG. 4, the host device 400 according to some example embodiments of the present inventive concepts may include a storage 410 and a processor 420.

The processor 420 may be configured to acquire query information from the storage of a storage device based on a B-tree query request for a table; send the query information to the storage device for storing into a memory of the storage device; send the B-tree query request to the storage device to initiate a query for the table at the storage device; and receive a result of the B-tree query request from the storage device.

Only as an example rather than a limitation, a target field of the B-tree query request may be a field that is not contained in leaf nodes of a secondary index of the table. In addition, the query information may include at least one of all fields of the table and length information thereof, at least one field of the table requested to be queried by the B-tree query request, page number information of root nodes of a primary index and the secondary index of the table, and a size of a B-tree page.

According to some example embodiments of the present inventive concepts, the processor 420 may further be configured to package the B-tree query request and the query information through a predetermined (or, alternatively, desired or selected) protocol to send to the storage device.

According to some example embodiments of the present inventive concepts, the processor 420 may include hardware or hardware circuitry having logic circuitry; a hardware/software combination, for example, a processor executing software and/or firmware; or a combination thereof. For example, more specifically, the processor 420 may include, but is not limited to, a central processing unit (CPU), an arithmetic logic unit (ALU), a digital signal processor, a microcomputer, a field programmable gate array (FPGA), a system on a chip (SoC), a programmable logic unit, a microprocessor, an application specific integrated circuit (ASIC), etc.

In addition to the above components, the host device 400 according to some example embodiments of the present inventive concepts may further include an interface module for sending/receiving data, etc. for implementing corresponding functions, which will not be described here.

FIG. 5 is a block diagram illustrating a storage device 500 according to some example embodiments of the present inventive concepts.

Referring to FIG. 5, the storage device 500 according to some example embodiments of the present inventive concepts may include a storage 510, a memory 520 and a processor 530.

The processor 530 may be configured to receive, from a host device, and store query information into the memory; receive a B-tree query request from the host device to initiate a query for a table; acquire a result of the B-tree query request by using the query information; and send the result of the B-tree query request to the host device.

Only as an example rather than a limitation, a target field of the B-tree query request may be a field that is not contained in leaf nodes of a secondary index of the table. In addition, the query information may include at least one of all fields of the table and length information thereof, at least one field of the table requested to be queried by the B-tree query request, page number information of root nodes of a primary index and the secondary index of the table, and a size of a B-tree page.

According to some example embodiments of the present inventive concepts, the processor 530 may further be configured to acquire a primary key value of a root page of at least one target root node of the table corresponding to the B-tree query request by traversing and retrieving a root page of each root node of the secondary index of the table using the query information; and acquire a key value of the target field corresponding to the B-tree query request as the result of the B-tree query request by traversing and retrieving a root page of a root node, corresponding to the primary key value, of the primary index of the table using the query information.

According to some example embodiments of the present inventive concepts, more specifically, the processor may further be configured to, based on all fields of the table and length information thereof and the page number information of root nodes of the secondary index of the table, load the root page of each root node of the secondary index of the table stored in a storage of the storage device into the memory of the storage device with the size of the B-tree page respectively for retrieval, so as to acquire the primary key value of the root page of the at least one target root node.

According to some example embodiments of the present inventive concepts, more specifically, the processor may further be configured to, based on all fields of the table and length information thereof, and the page number information of root nodes of the primary index of the table, load the root page of the root node, corresponding to the primary key value, of the primary index of the table stored in the storage of the storage device into the memory of the storage device with the size of the B-tree page respectively for retrieval, so as to acquire the key value of the target field.

According to some example embodiments of the present inventive concepts, the processor 530 may further be configured to sort the primary key value, and sequentially load root pages of root nodes corresponding to the sorted primary key value into the memory of the storage device for retrieval.

In addition to the above components, the storage device 500 according to some example embodiments of the present inventive concepts may further include an interface module for sending/receiving data, etc. for implementing corresponding functions, which will not be described here.

According to some example embodiments of the present inventive concepts, the processor 530 may include hardware or hardware circuitry having logic circuitry; a hardware/software combination, for example, a processor executing software and/or firmware; or a combination thereof. For example, more specifically, the processor 530 may include, but is not limited to, a central processing unit (CPU), an arithmetic logic unit (ALU), a digital signal processor, a microcomputer, a field programmable gate array (FPGA), a system on a chip (SoC), a programmable logic unit, a microprocessor, an application specific integrated circuit (ASIC), etc.

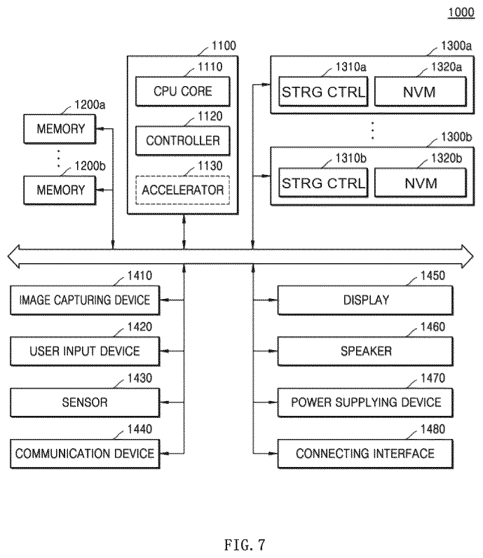

FIG. 6 is a block diagram illustrating a system 600 according to some example embodiments of the present inventive concepts.

Referring to FIG. 6, the system 600 according to some example embodiments of the present inventive concepts may include a host device 610 and a storage device 620. The host device 610 may be the same or similar to the host device 400 illustrated in FIG. 4, and the storage device 620 may be the same or similar to the storage device 500 illustrated in FIG. 5, which will not be described here.

FIG. 7 is a schematic diagram illustrating a system 1000 to which a storage device is applied according to some example embodiments of the present inventive concepts.

The system 1000 of FIG. 7 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 7 is not necessarily limited to the mobile system and may be a PC, a laptop computer, a server, a media player, or an automotive device (e.g., a navigation device).

Referring to FIG. 7, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

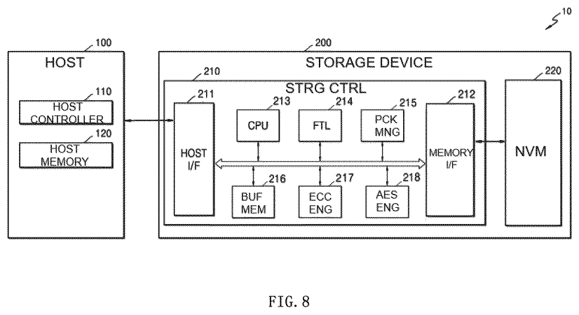

FIG. 8 is a block diagram of a host storage system 10 according to some example embodiments of the present inventive concepts.

The host storage system 10 may include a host 100 and a storage device 200. Further, the storage device 200 may include a storage controller 210 and an NVM 220. According to some example embodiments of the present inventive concepts, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

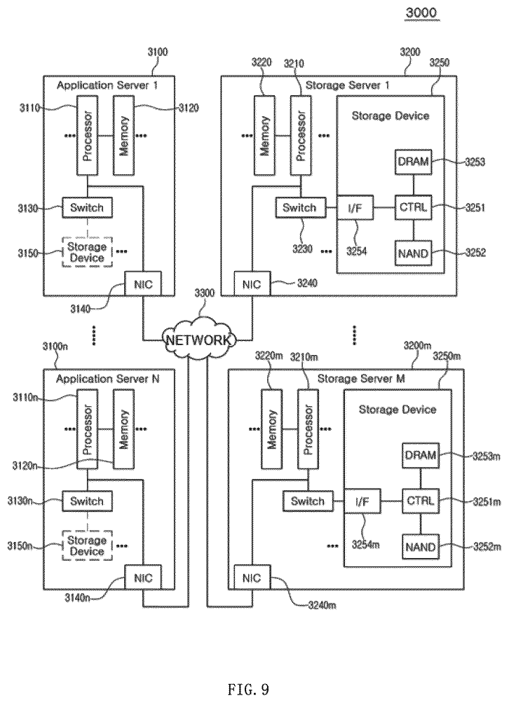

FIG. 9 is a diagram illustrating a data center 3000 to which a storage device is applied according to some example embodiments of the present inventive concepts.

### Platform Portion—Server (Application/Storage)

Referring to FIG. 9, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In some example embodiments, the processor 3210 and the memory 3220 may provide a processor-memory pair. In some example embodiments, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to some example embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to some example embodiments of the present inventive concepts, there is provided a computer-readable medium having stored thereon computer executable instructions that, when executed, execute the previously mentioned method. Examples of the computer-readable medium here may include Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state drive (SSD), card storage (such as, Multimedia Cards, Secure Digital (SD) Cards or Extreme Digital (XD) Cards), magnetic tapes, floppy disks, magneto-optical data storage devices, optical data storage devices, hard disks, solid state disks, and any other device. The any other device is configured to store a computer program and any relevant data, data files and data structures in a non-transitory manner and to provide the computer program and any relevant data, data files and data structures to a processor or computer, so that the processor or computer can execute the computer program. The computer program in the above computer-readable medium may run in an environment deployed in computer devices such as a client, a host, an agent device, and a server. In addition, in an example, the computer program and any relevant data, data files and data structures are distributed over networked computer systems, so that the computer program and any relevant data, data files and data structures are stored, accessed, and executed in a distributed manner by one or more processors or computers.

According to example embodiments of the present inventive concepts, by retrieving target data inside a storage device, a large amount of data migration between a host device and the storage device may be avoided, so that an amount of data movement between the host device and the storage device may be reduced, a resource utilization rate and a bandwidth consumption of the host device may be reduced and a bandwidth utilization rate may be improved, an I/O bandwidth in the storage device may be improved, a delay of retrieving the target data may be reduced, and retrieval performance may be improved. Therefore, the improved devices and methods overcome the deficiencies of the conventional devices and methods of accessing data, particularly related to retrieving target data inside a storage device, while reducing resource consumption (e.g., processing capability, power, bandwidth), improving data accuracy, and resource allocation (e.g., latency).

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

Although the present inventive concepts have been illustrated and described with reference to some specific example embodiments, it will be understood by those skilled in the art that various changes in form and detail may be made without departing from the spirit and scope of the present inventive concepts as defined by the claims and the equivalents thereof.

1.-4. (canceled)

5. A host device, comprising:
a storage; and
a processor configured to:
acquire query information from the storage of a storage device based on a B-tree query request for a table;
send the query information to the storage device for storing into a memory of the storage device;
send the B-tree query request to the storage device to initiate a query for the table at the storage device; and
receive a result of the B-tree query request from the storage device.

6. The host device of claim 5, wherein a target field of the B-tree query request is a field that is not contained in leaf nodes of a secondary index of the table.

7. The host device of claim 6, wherein the query information comprises at least one of all fields of the table and length information thereof, at least one field of the table requested to be queried by the B-tree query request, page number information of root nodes of a primary index and the secondary index of the table, and a size of a B-tree page.

8. The host device of claim 5, wherein the at least one processor is further configured to package the B-tree query request and the query information through a protocol to send to the storage device.

9. A B-tree based retrieval method performed by a storage device, comprising:
receiving, from a host device, and storing query information into a memory;
receiving a B-tree query request from the host device to initiate a query for a table;
acquiring a result of the B-tree query request by using the query information; and
sending the result of the B-tree query request to the host device.

10. The B-tree based retrieval method of claim 9, wherein a target field of the B-tree query request is a field that is not contained in leaf nodes of a secondary index of the table.

11. The B-tree based retrieval method of claim 10, wherein the query information comprises:
at least one of all fields of the table and length information thereof,
at least one field of the table requested to be queried by the B-tree query request,
page number information of root nodes of a primary index and the secondary index of the table, and
a size of a B-tree page.

12. The B-tree based retrieval method of claim 11, wherein the acquiring the result of the B-tree query request comprises:
acquiring a primary key value of a root page of at least one target root node of the table corresponding to the B-tree query request by traversing and retrieving a root page of each root node of the secondary index of the table using the query information; and
acquiring a key value of the target field corresponding to the B-tree query request as the result of the B-tree query request by traversing and retrieving a root page of a root node, corresponding to the primary key value, of the primary index of the table using the query information.

13. The B-tree based retrieval method of claim 12, wherein the acquiring the primary key value of the root page of at least one target root node of the table corresponding to the B-tree query request comprises:
based on all fields of the table and length information thereof and the page number information of root nodes of the secondary index of the table, loading the root page of each root node of the secondary index of the table stored in a storage of the storage device into the memory of the storage device with the size of the B-tree page respectively for retrieval, so as to acquire the primary key value of the root page of the at least one target root node.

14. The B-tree based retrieval method of claim 12, wherein the acquiring the key value of the target field corresponding to the B-tree query request as the result of the B-tree query request comprises:
based on all fields of the table and length information thereof and the page number information of root nodes of the primary index of the table, loading the root page of the root node, corresponding to the primary key value, of the primary index of the table stored in the storage of the storage device into the memory of the storage device with the size of the B-tree page respectively for retrieval, so as to acquire the key value of the target field.

15. The B-tree based retrieval method of claim 13, further comprising:
sorting the primary key value, and sequentially loading root pages of root nodes corresponding to the sorted primary key value into the memory of the storage device for retrieval.

16. A storage device comprising:
a storage;
a memory; and
a processor configured to:
receive, from a host device, and store query information into the memory;
receive a B-tree query request from the host device to initiate a query for a table;
acquire a result of the B-tree query request by using the query information; and
send the result of the B-tree query request to the host device.

17. The storage device of claim 16, wherein a target field of the B-tree query request is a field that is not contained in leaf nodes of a secondary index of the table.

18. The storage device of claim 17, wherein the query information comprises
at least one of all fields of the table and length information thereof,
at least one field of the table requested to be queried by the B-tree query request,
page number information of root nodes of a primary index and the secondary index of the table, and
a size of a B-tree page.

19. The storage device of claim 18, wherein the processor is further configured to:
acquire a primary key value of a root page of at least one target root node of the table corresponding to the B-tree query request by traversing and retrieving a root page of each root node of the secondary index of the table using the query information; and
acquire a key value of the target field corresponding to the B-tree query request as the result of the B-tree query request by traversing and retrieving a root page of a root node, corresponding to the primary key value, of the primary index of the table using the query information.

20. The storage device of claim 19, wherein the processor is further configured to:
based on all fields of the table and length information thereof and the page number information of root nodes of the secondary index of the table, loading the root page of each root node of the secondary index of the table stored in a storage of the storage device into the memory of the storage device with the size of the B-tree page respectively for retrieval, so as to acquire the primary key value of the root page of the at least one target root node.

21. The storage device of claim 19, wherein the processor is further configured to:
based on all fields of the table and length information thereof, and the page number information of root nodes of the primary index of the table, loading the root page of the root node, corresponding to the primary key value, of the primary index of the table stored in the storage of the storage device into the memory of the storage device with the size of the B-tree page respectively for retrieval, so as to acquire the key value of the target field.

22. The storage device of claim 20, wherein the processor is further configured to:
sort the primary key value, and sequentially load root pages of root nodes corresponding to the sorted primary key value into the memory of the storage device for retrieval.

23.-24. (canceled)
